(19) United States
(12) Patent Application Publication
(10) Pub. No.: US 2026/0225385 A1
(43) Pub. Date: Aug. 6, 2026

(54) RECORDING APPARATUS AND PACKING METHOD

(71) Applicant: SEIKO EPSON CORPORATION, TOKYO (JP)

(72) Inventors: Takuro FURUSAWA, SHIOJIRI-SHI (JP); Satoshi YOSHINO, Matsumoto-shi (JP); Shigeaki ISOBE, Matsumoto-shi (JP)

(21) Appl. No.: 19/464,741

(22) Filed: Jan. 30, 2026

(30) Foreign Application Priority Data
Jan. 31, 2025 (JP) 2025-014796

(51) Int. Cl. B41J 29/02; B41J 11/58; B41J 13/03; B41J 13/10

(52) U.S. Cl. CPC B41J 29/02; B41J 11/58; B41J 13/03; B41J 13/103; B41J 13/106

(57) ABSTRACT

A recording apparatus includes a housing, a recording unit that records on a medium, an ejection unit that ejects the recorded medium, and a placement unit with a first surface for placing the ejected medium, formed of one member. The housing includes a support unit that supports the placement unit. The placement unit is displaceable between a first state, where it is entirely within the housing, and a second state, where at least part of it protrudes from the housing along a pull-out direction in contact with the support unit. In the first state, the support unit supports the placement unit inclined at a first angle relative to the installation surface of the apparatus. In the second state, the support unit supports the placement unit inclined at a second angle, larger than the first angle, relative to the installation surface.

The present application is based on, and claims priority from JP Application Serial Number 2025-014796, filed January 31, 2025, the disclosure of which is hereby incorporated by reference herein in its entirety.

### BACKGROUND

### 1. Technical Field

The present disclosure relates to a recording apparatus and a packing method.

### 2. Related Art

In the related art, a recording apparatus including a placement unit on which a medium on which recording is performed by a recording unit and ejected from an ejection unit can be placed is used. For example, JP-A-2022-97512 discloses a recording apparatus including an ejection tray on which a medium ejected from an ejection port after recording is performed by ejecting ink from a recording head can be placed.

JP-A-2022-97512 is an example of the related art.

In a recording apparatus in the related art including a placement unit on which a medium on which recording is performed by a recording unit and ejected from an ejection unit can be placed, there is a concern that the medium may jump out from the placement unit when the medium is ejected from the ejection unit to the placement unit. Therefore, in the recording apparatus disclosed in JP-A-2022-97512, a deployment tray is attached as a stopper that prevents the medium from jumping out of the paper ejection tray when the medium is ejected from the ejection port to the paper ejection tray. The recording apparatus disclosed in JP-A-2022-97512 can prevent the medium from jumping out of the paper ejection tray when the medium is ejected from the ejection port to the paper ejection tray, but the paper ejection tray is provided with the deployment tray that is a separate member, and thus the structure is not simple.

### SUMMARY

A recording apparatus according to an aspect of the present disclosure includes a housing, a recording unit that performs recording on a medium, an ejection unit that ejects the medium on which recording has been performed by the recording unit, and a placement unit having a first surface on which the medium ejected by the ejection unit is placeable and formed of one member, wherein the housing has a support unit configured to support the placement unit, the placement unit is configured to be displaced between a first state in which the entire placement unit is located in the housing and a second state in which at least a part of the placement unit protrudes from the housing by moving along a pull-out direction in contact with the support unit, and the support unit supports the placement unit inclined at a first angle with respect to an installation surface of the recording apparatus in the first state, and supports the placement unit inclined at a second angle larger than the first angle with respect to the installation surface in the second state.

### BRIEF DESCRIPTION OF THE DRAWINGS

FIG. 1 is a perspective view of a recording apparatus according to one embodiment of the present disclosure.

FIG. 2 is a side cross-sectional view of the recording apparatus in FIG. 1.

FIG. 3 is a front view of the recording apparatus in FIG. 1, in which a housing is detached.

FIG. 4 is a side cross-sectional view around a placement unit and a support unit of the recording apparatus in FIG. 1, in which the placement unit is in a first state.

FIG. 5 is a side cross-sectional view around the placement unit and the support unit of the recording apparatus in FIG. 1, in which the placement unit is at a position between the first state and a second state.

FIG. 6 is a side cross-sectional view around the placement unit and the support unit of the recording apparatus in FIG. 1, in which the placement unit is in the second state.

FIG. 7 is a perspective view of the placement unit of the recording apparatus in FIG. 1.

FIG. 8 is a plan cross-sectional view around the placement unit and the support unit of the recording apparatus in FIG. 1, in which the placement unit is in the first state.

FIG. 9 is a plan cross-sectional view around the support unit of the recording apparatus in FIG. 1, in which the placement unit is detached.

FIG. 10 is a perspective view of the placement unit of the recording apparatus in FIG. 1 as viewed from an angle different from that of FIG. 7.

FIG. 11 is a plan view of a placement unit of the recording apparatus in FIG. 1.

FIG. 12 is a cross-sectional view of the placement unit of the recording apparatus in FIG. 1 as viewed from the front side.

FIG. 13 is a cross-sectional view of the placement unit of the recording apparatus in FIG. 1 as viewed from the side.

FIG. 14 is a side cross-sectional view showing a state when the recording apparatus in FIG. 1 is packed.

FIG. 15 is a front view showing a state when the recording apparatus in FIG. 1 is packed.

FIG. 16 is a bottom view showing a state when the recording apparatus in FIG. 1 is packed.

### DESCRIPTION OF EMBODIMENTS

First, an overview of the present disclosure will be described.

A recording apparatus according to a first aspect of the present disclosure for solving the above-describe problem includes a housing, a recording unit that performs recording on a medium, an ejection unit that ejects the medium on which recording has been performed by the recording unit, and a placement unit having a first surface on which the medium ejected by the ejection unit is placeable and formed of one member, wherein the housing has a support unit configured to support the placement unit, the placement unit is configured to be displaced between a first state in which the entire placement unit is located in the housing and a second state in which at least a part of the placement unit protrudes from the housing by moving along a pull-out direction in contact with the support unit, and the support unit supports the placement unit inclined at a first angle with respect to an installation surface of the recording apparatus in the first state, and supports the placement unit inclined at a second angle larger than the first angle with respect to the installation surface in the second state.

According to the aspect, in the second state when the medium is placed, the support unit supports the placement unit formed of one member so as to be inclined at the second angle larger than the first angle in the first state. According to the configuration, it is possible to reduce the possibility that the medium jumps out from the placement unit when the medium is ejected from the ejection unit to the placement unit by using the placement unit that is simply configured with one member. That is, the medium can be suitably placed on the placement unit with a simple configuration without increasing the number of components.

A recording apparatus according to a second aspect of the present disclosure is an aspect according to the first aspect , wherein the placement unit has a protruding portion provided on the first surface, the support unit has a first support portion configured to come into contact with a second surface that is a surface opposite to the first surface, a second support portion located downstream of the first support portion in the pull-out direction and configured to come into contact with the second surface, a third support portion located downstream of the second support portion in the pull-out direction and configured to come into contact with the second surface, and a fourth support portion configured to come into contact with the protruding portion in the second state, the protruding portion has an inclined surface inclined such that a protrusion distance with respect to the first surface decreases toward the pull-out direction, and a contact surface coupled to the inclined surface on a side opposite to the pull-out direction, and the fourth support portion slides on the inclined surface and the contact surface when the placement unit is displaced from the first state to the second state.

According to the aspect, when the placement unit is displaced from the first state to the second state, the fourth support portion slides on the inclined surface and the contact surface of the protruding portion provided on the first surface of the placement unit. In this way, the inclination angle can be increased in the second state by a simple operation of pulling out the fourth support portion while sliding the portion on the inclined surface and the contact surface.

A recording apparatus according to a third aspect of the present disclosure is an aspect according to the second aspect, wherein at least two of each of the first support portion, the second support portion, and the third support portion are provided at a distance in an apparatus width direction intersecting the pull-out direction, the first support portion comes into contact with the second surface when the placement unit is in the first state, the second support portion comes into contact with the second surface when the placement unit is in the second state, and the third support portion comes into contact with the second surface when the placement unit is in both the first state and the second state.

According to the aspect, the at least two first support portions are in contact with the second surface when the placement unit is in the first state, the at least two second support portions are in contact with the second surface when the placement unit is in the second state, and the at least two third support portions are in contact with the second surface when the placement unit is in both the first state and the second state. Therefore, the placement unit is supported at least at four points in both the first state and the second state. Therefore, the attitude of the placement unit is stabilized in both the first state and the second state.

A recording apparatus according to a fourth aspect of the present disclosure is an aspect according to the second or third aspect, wherein the placement unit has a groove portion configured to avoid a state of being supported by the fourth support portion, a bottom surface of the groove portion is located downstream of the contact surface in a depth direction from the first surface toward the second surface, and the groove portion is coupled to the inclined surface in the pull-out direction, overlaps a trajectory of the fourth support portion when at least the placement unit is displaced between the first state and the second state when viewed from the depth direction, and overlaps a trajectory of the fourth support portion when at least the placement unit is displaced between the first state and the second state when viewed from the pull-out direction.

According to the aspect, the placement unit includes the groove portion capable of avoiding a state of being supported by the fourth support portion, the bottom surface of the groove portion is located downstream of the contact surface in the depth direction from the first surface toward the second surface, the groove portion is coupled to the inclined surface in the pull-out direction, and overlaps the trajectory of the fourth support portion when at least the placement unit is displaced between the first state and the second state when viewed from the depth direction. According to the configuration, it is possible to change the angle of the placement unit as the placement unit is pulled out.

A recording apparatus according to a fifth aspect of the present disclosure is an aspect according to the fourth aspect, wherein the placement unit has a restriction portion upstream of the contact surface in the pull-out direction, and the restriction portion is located upstream of the contact surface in the depth direction and restricts the movement of the placement unit in the pull-out direction by coming into contact with the fourth support portion.

According to the aspect, the restriction portion that restricts the movement of the placement unit in the pull-out direction by coming into contact with the fourth support portion is provided upstream of the contact surface in the pull-out direction and upstream of the contact surface in the depth direction. Since the restriction portion is provided, it is possible to prevent the placement unit from coming off the recording apparatus when the placement unit is pulled out in the pull-out direction.

A recording apparatus according to a sixth aspect of the present disclosure is an aspect according to any one of the first to fifth aspects including a feed tray on which a medium on which recording is to be performed by the recording unit is placed, and a feed roller that feeds the medium placed on the feed tray, wherein the placement unit overlaps the feed roller when viewed from a vertical direction in the first state.

According to the aspect, the placement unit overlaps the feed roller when viewed from the vertical direction in the first state. According to the configuration, the recording apparatus can be miniaturized.

A recording apparatus according to a seventh aspect of the present disclosure is an aspect according to any one of the first to sixth aspects, wherein the first surface has a curved shape in which a center is recessed in a cross section viewed from the pull-out direction.

According to the aspect, the first surface has the curved shape in which the center is recessed in the cross section viewed from the pull-out direction. According to the configuration, the medium can be placed in a curved manner, and the alignment of the medium placed on the placement unit can be improved.

A recording apparatus according to an eighth aspect of the present disclosure is an aspect according to the seventh aspect, wherein the placement unit has a handle portion in an upstream end portion in the pull-out direction, and the handle portion has a wall portion protruding from the first surface and a curved surface coupling the first surface and the wall portion.

According to the aspect, the handle portion is provided in the upstream end portion in the pull-out direction, and the handle portion includes the wall portion protruding from the first surface and the curved surface coupling the first surface and the wall portion. With the handle portion having such a configuration, the user can easily pull out the placement unit.

A recording apparatus according to a ninth aspect of the present disclosure is an aspect according to any one of the first to eighth aspects, including a feed tray, at least a part of which is provided downstream of the housing in the pull-out direction, on which a medium on which recording is to be performed by the recording unit is placed, and a feed roller that feeds the medium placed on the feed tray, wherein the medium placed on the feed tray is ejected to the placement unit toward upstream in the pull-out direction, the recording unit performs recording on the medium conveyed from the feed tray to the placement unit by ejecting liquid supplied from a container that contains the liquid, and the housing has a storage portion configured to store at least a part of the container.

According to the aspect, in the configuration in which the feed tray is provided downstream in the pull-out direction, the housing includes the storage portion capable of storing at least a part of the container. According to the configuration, the container can be stored in the housing at the time of packing or the like, and a space for installing the container outside the housing can be reduced.

A recording apparatus according to a tenth aspect of the present disclosure is an aspect according to the ninth aspect, wherein the storage portion is configured to store at least a part of the container held by a packing member.

According to the aspect, the storage portion can store at least a part of the container held by the packing member. According to the configuration, it is possible to prevent the container from moving in the storage portion.

A packing method according to an eleventh aspect of the present disclosure is a packing method for the recording apparatus according to the ninth or tenth aspect, including storing at least a part of the container with the placement unit set in the first state when packing the recording apparatus.

According to the aspect, when the recording apparatus is packed, at least a part of the container is stored in the storage portion with the placement unit set in the first state. In this way, it is possible to prevent the placement unit from being detached and set outside the housing, and it is possible to prevent an increase in size of the package.

A packing method according to a twelfth aspect of the present disclosure is a packing method for the recording apparatus according to the ninth or tenth aspect, the placement unit is provided in a part of the storage portion, the packing method includes detaching the placement unit from the recording apparatus and storing at least a part of the container in the storage portion when packing the recording apparatus.

According to the aspect, when the recording apparatus is packed, the placement unit is detached from the recording apparatus and at least a part of the container is stored in the storage portion. In this way, a large number of containers can be stored in the storage portion.

A packing method according to a thirteenth aspect of the present disclosure is a packing method according to the eleventh or twelfth aspect, wherein the storage portion is positioned below the recording unit when the recording apparatus is packed.

According to the aspect, when the recording apparatus is packed, the storage portion is positioned below the recording unit. In this way, for example, even when the liquid in the container leaks, it is possible to reduce the possibility that the liquid adheres to the recording unit.

A packing method according to a fourteenth aspect of the present disclosure is a packing method according to any one of the eleventh to thirteenth aspects, wherein the storage portion is positioned below the feed roller when the recording apparatus is packed.

According to the aspect, when the recording apparatus is packed, the storage portion is positioned below the feed roller. In this way, for example, even when the liquid in the container leaks, it is possible to reduce the possibility that the liquid adheres to the feed roller.

A packing method according to a fifteenth aspect of the present disclosure is a packing method according to any one of the eleventh to fourteenth aspects, wherein the storage portion is positioned below a conveyance path of the medium conveyed from the feed tray to the placement unit when the recording apparatus is packed.

According to the aspect, when the recording apparatus is packed, the storage portion is positioned below the conveyance path of the medium. In this way, for example, even when the liquid in the container leaks, it is possible to reduce the possibility that the liquid adheres to the conveyance path of the medium.

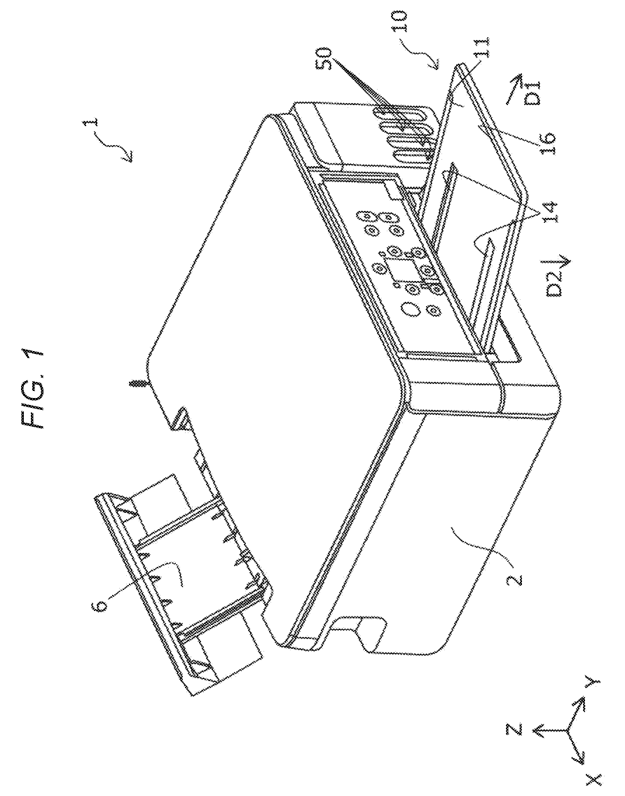

The present disclosure will be specifically be described below. First, an outline of a recording apparatus 1 according to one embodiment of the present disclosure will be described with reference to FIGS. 1 to 3. In an X-Y-Z coordinate system shown in the drawings, X-axis directions are lateral directions, that is, width directions of the apparatus, Y-axis directions are a frontward direction (front direction) and a backward direction of the apparatus, and Z-axis directions are a height direction and a gravity direction of the apparatus. A forward side in a movement direction such as a direction in which a medium M is conveyed is referred to as "downstream", and a backward side as the opposite side in the movement direction is referred to as "upstream". In the drawings, in order to facilitate understanding of an internal configuration and the like, part of component members may be omitted or simplified.

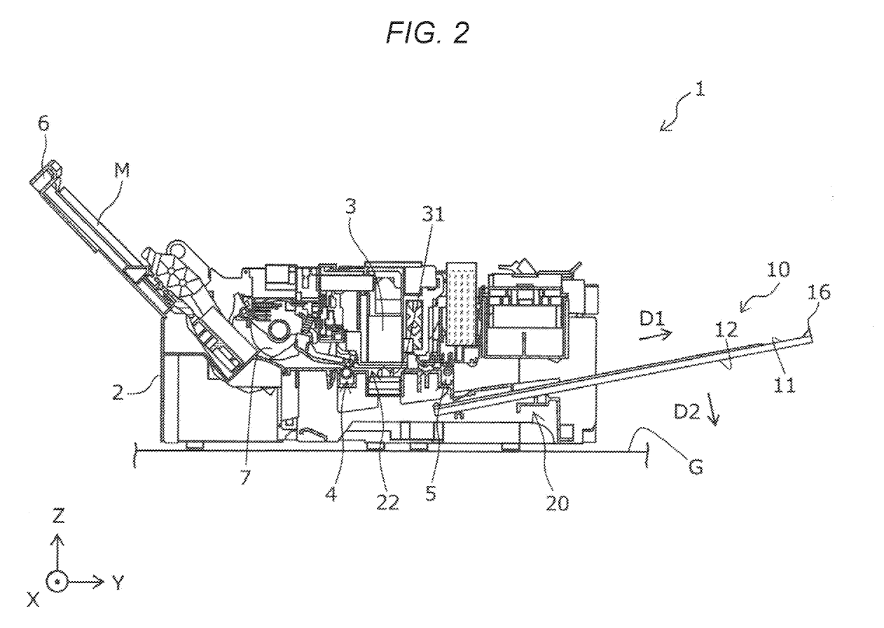

As illustrated in FIGS. 1 and 2, the recording apparatus 1 includes a feed tray 6 on which the medium M on which recording is to be performed by a recording unit 3 described later is placed, a feed roller 7 that feeds the medium M placed on the feed tray 6, and a housing 2. As illustrated in FIGS. 1 and 2, the feed tray 6 can take an attitude in which the medium M partially protrudes from the housing 2 as an attitude when the medium M is placed.

As illustrated in FIG. 2, the recording apparatus 1 includes the recording unit 3 that performs recording on the medium M and a conveyance unit 4 that conveys the medium M inside the housing 2. The recording unit 3 includes a recording head 31 that performs recording on the medium M by supplying ink from a container 50 containing liquid ink and disposed inside the housing 2 illustrated in FIG. 1. The recording head 31 may be a line head of a line recording type having a length corresponding to the maximum width of the medium M, or a line head of a serial recording type. In the serial recording type, recording is performed on the medium M by alternately performing a conveyance operation in which the conveyance unit 4 conveys the medium M to a subsequent recording position and a recording operation in which the recording unit 3 performs recording for one line (one pass) on the medium M while moving in the X-axis direction (scanning direction).

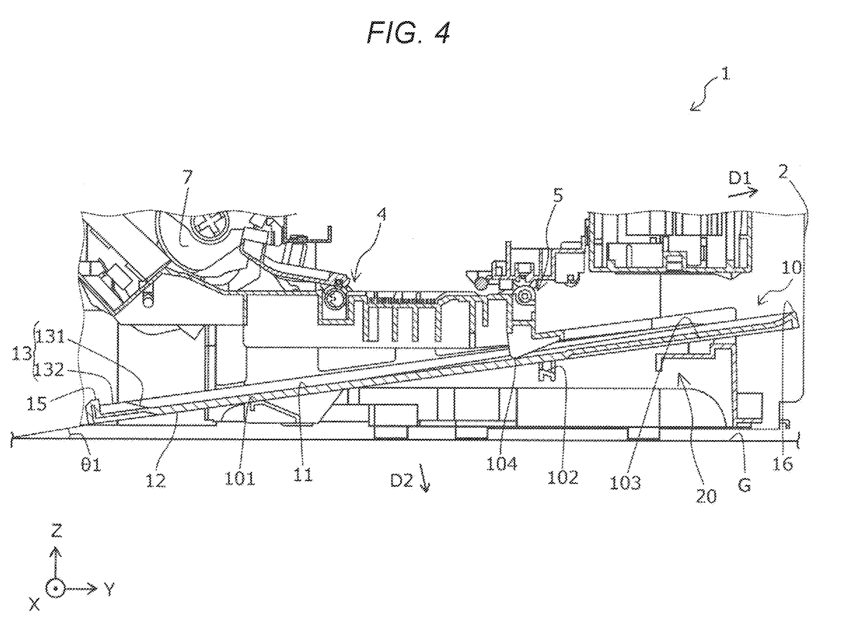

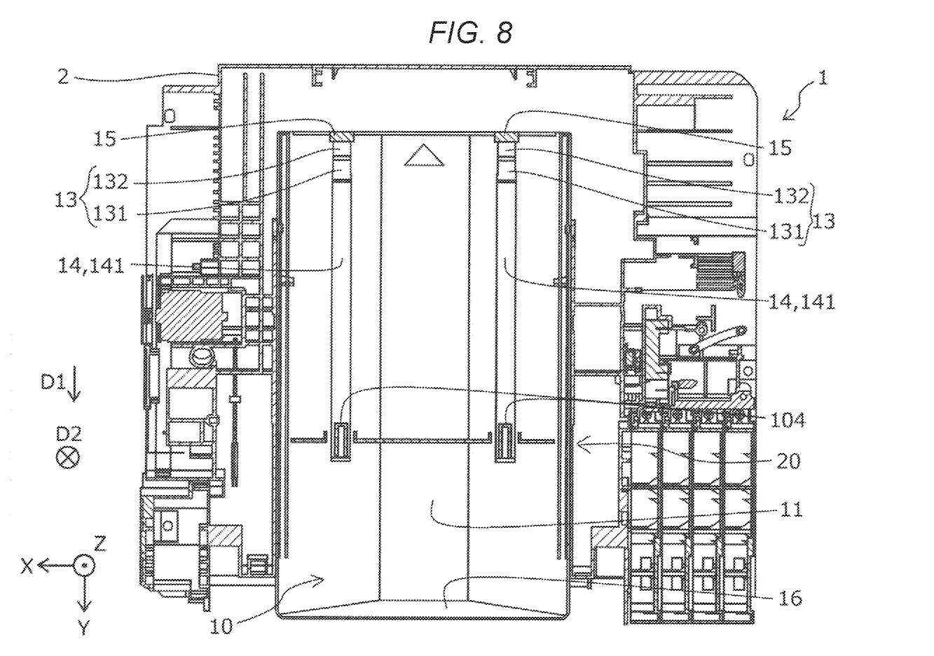

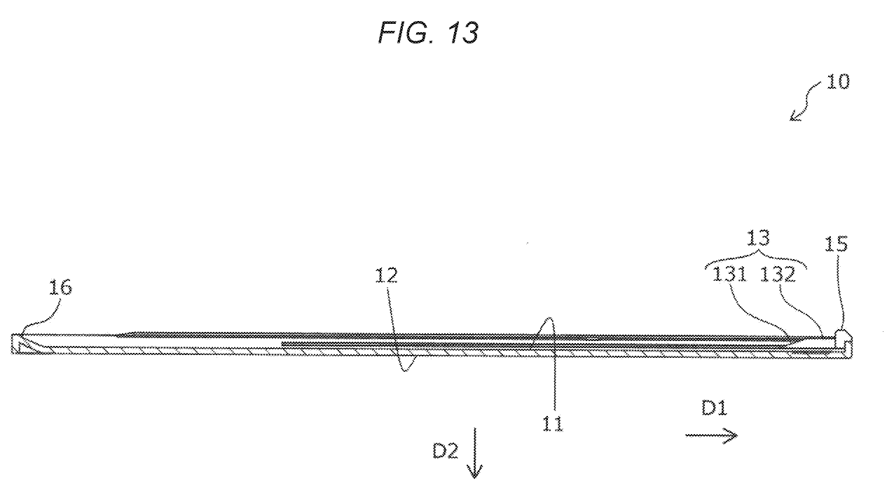

In addition, as illustrated in FIGS. 1 to 3, the recording apparatus 1 includes an ejection unit 5 that ejects the medium M on which recording is performed by the recording unit 3, and a placement unit 10 having a first surface 11 on which the medium M ejected by the ejection unit 5 can be placed and is formed of one member. Here, as illustrated in FIG. 2, the housing 2 includes a support unit 20 capable of supporting the placement unit 10. Hereinafter, the details of the placement unit 10 and the support unit 20 will be described with reference to FIGS. 4 to 13 in addition to FIGS. 1 to 3.

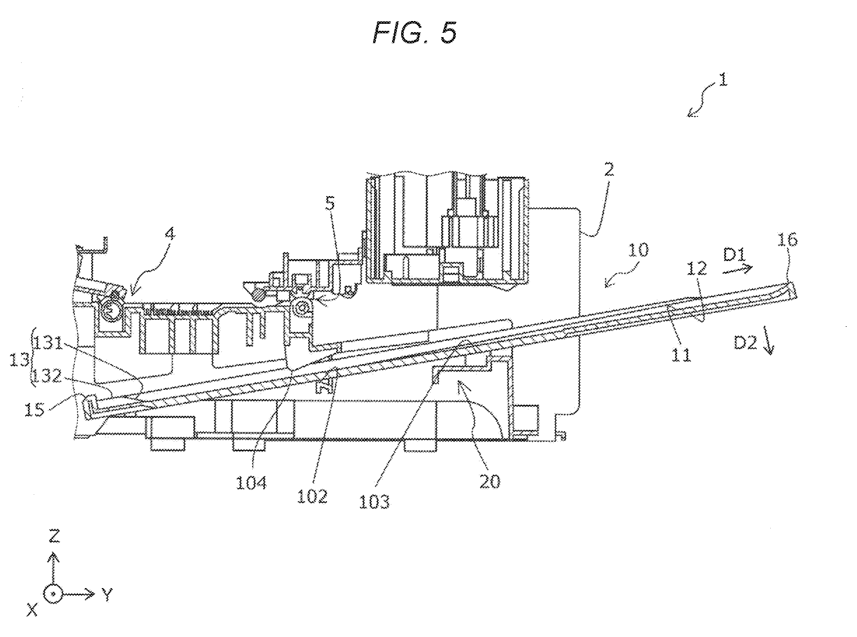

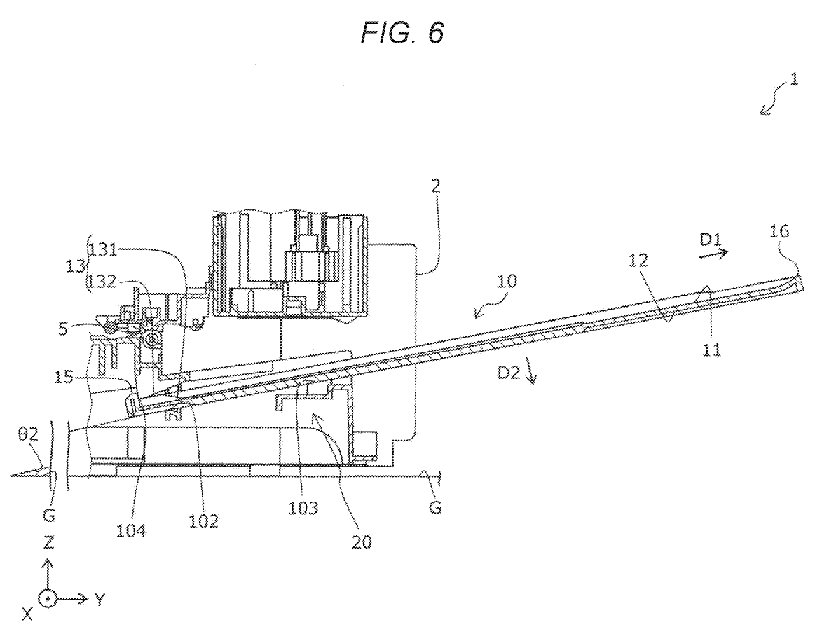

By moving in contact with the support unit 20 along a pull-out direction D1, the placement unit 10 can be displaced to a housed state in which the entire placement unit is housed inside the housing 2 as illustrated in FIG. 4, a protruding state in which the placement unit protrudes from the housing 2 as illustrated in FIG. 6, and an intermediate state between the housed state and the protruding state as illustrated in FIG. 5. From another viewpoint, the placement unit 10 can be displaced between a first state corresponding to the housed state in FIG. 4, in which the entire placement unit 10 is located in the housing 2 and a second state corresponding to the protruding state in FIG. 6, in which at least a part of the placement unit 10 protrudes from the housing 2. The first state can be expressed as a state in which the medium M is not placed on the first surface 11, and the second state can be expressed as a state in which the medium M is placed on the first surface 11.

Here, the support unit 20 supports the placement unit 10 inclined at a first angle θ1 with respect to an installation surface G of the recording apparatus 1 in the first state as the housed state illustrated in FIG. 4, and supports the placement unit 10 inclined at a second angle θ2 with respect to the installation surface G of the recording apparatus 1 in the second state as the protruding state illustrated in FIG. 6. The second angle θ2 is larger than the first angle θ1. According to the configuration, in the recording apparatus 1, the possibility of the medium M jumping out from the placement unit 10 when the medium M is ejected from the ejection unit 5 to the placement unit 10 can be reduced by using the placement unit 10 that is simply configured with one member. That is, in the recording apparatus 1, the medium M can be suitably placed on the placement unit 10 with a simple configuration without increasing the number of components.

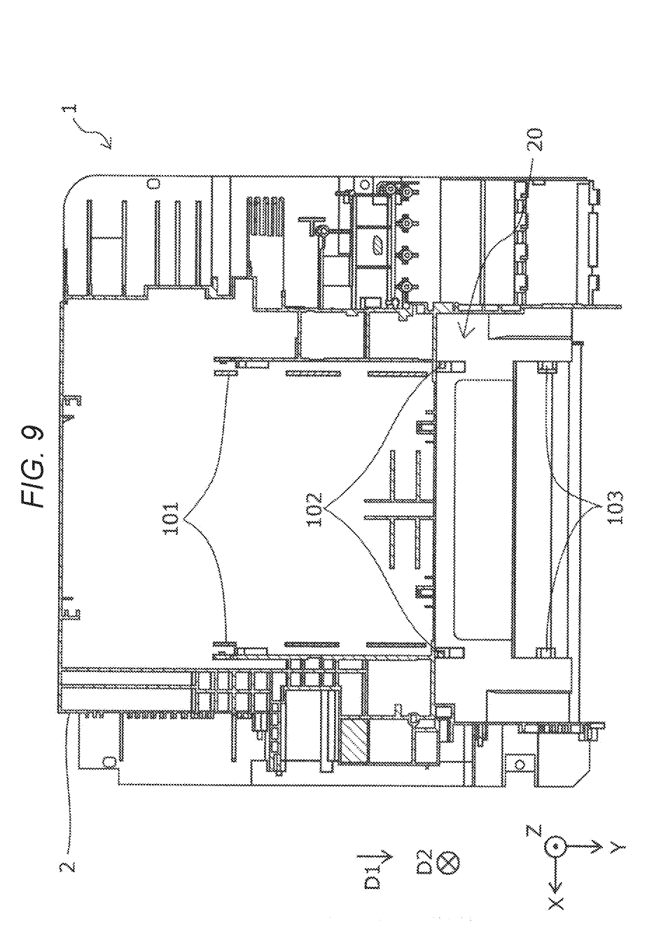

Hereinafter, the contact position between the placement unit 10 and the support unit 20 will be described in detail. As shown in FIG. 4 to FIG. 8 and FIG. 9 to FIG. 13, the placement unit 10 has a protruding portion 13 on the first surface 11. As illustrated in FIGS. 4 and 9, the support unit 20 includes a first support portion 101 that can come into contact with a second surface 12 that is a surface opposite to the first surface 11 of the placement unit 10. As illustrated in FIGS. 4 to 6 and 9, the support unit 20 includes a second support portion 102 that is located downstream of the first support portion 101 in the pull-out direction D1 and can come into contact with the second surface 12. As illustrated in FIGS. 4 to 6 and 9, the support unit 20 includes a third support portion 103 that is located downstream of the second support portion 102 in the pull-out direction D1 and can come into contact with the second surface 12. Furthermore, as illustrated in FIGS. 4 to 6 and FIG. 8, the support unit 20 includes a fourth support portion 104 that comes into contact with the protruding portion 13 of the placement unit 10 in the second state.

Here, as illustrated in FIGS. 4 to 8 and FIGS. 9 to 13, the protruding portion 13 has an inclined surface 131 inclined with respect to the first surface 11, and a contact surface 132 coupled to the inclined surface 131 on the side opposite to the pull-out direction D1. The inclined surface 131 is inclined such that the protrusion distance with respect to the first surface 11 decreases toward the pull-out direction D1. The fourth support portion 104 slides on the inclined surface 131 and the contact surface 132 when the placement unit 10 is displaced from the first state to the second state. FIG. 6 illustrates a state where the fourth support portion 104 is in contact with the contact surface 132. According to the configuration, in the recording apparatus 1, the inclination angle can be increased in the second state by a simple operation of pulling out the fourth support portion 104 while sliding the portion on the inclined surface 131 and the contact surface 132.

More specifically, when the placement unit 10 is pulled out from the state in FIG. 4 to the state in FIG. 6, the angle of the placement unit 10 with respect to the installation surface G remains the first angle θ1 until the protruding portion 13 of the placement unit 10 and the fourth support portion 104 come into contact with each other, but the angle of the placement unit 10 with respect to the installation surface G increases as the protruding portion 13 of the placement unit 10 and the fourth support portion 104 are in further contact with each other, and finally, the angle of the placement unit 10 with respect to the installation surface G becomes the second angle θ2 in the state in FIG. 6. Note that, even in a configuration in which the angle of the placement unit 10 with respect to the installation surface G is the second angle θ2 throughout from the housed state illustrated in FIG. 4 to the protruding state illustrated in FIG. 6, the medium M can be suitably placed on the placement unit 10, but in such a configuration, the size of the recording apparatus 1 in the Z-axis direction increases.

Here, in the housed state illustrated in FIG. 4, the first support portion 101 and the third support portion 103 come into contact with the second surface 12. In the housed state illustrated in FIG. 4 to the intermediate state illustrated in FIG. 5, the third support portion 103 slides on the second surface 12. Since the backlash between the placement unit 10 and the support unit 20 in the Z-axis direction is large in the second support portion 102, the placement unit 10 and the support unit 20 may slide over each other or not in the second support portion 102 depending on the deviation of the pull-out direction D1 of the placement unit 10 in the Z-axis direction by the user. In contrast, the fourth support portion 104 is avoided by a groove portion 14 of the placement unit 10, which will be described later, and does not come into contact with the second surface 12.

In the intermediate state illustrated in FIG. 5 to the protruding state illustrated in FIG. 6, the second support portion 102, the third support portion 103, and the fourth support portion 104 slide on the second surface 12 as the placement unit 10 is pulled out. The fourth support portion 104 slides on the protruding portion 13 (the inclined surface 131 and the contact surface 132). Since the protruding portion 13 has a shape protruding substantially in a +Z direction, the placement unit 10 is at a steep angle with respect to the installation surface G in the protruding state when the placement unit 10 is completely pulled out.

More specifically, as illustrated in FIG. 9, two of each of the first support portions 101, the second support portions 102, and the third support portions 103 are provided at a distance in the apparatus width direction (X-axis direction) intersecting the pull-out direction D1. As illustrated in FIG. 4, the first support portion 101 is in contact with the second surface 12 when the placement unit 10 is in the first state. As illustrated in FIG. 6, the second support portion 102 is in contact with the second surface 12 when the placement unit 10 is in the second state. As illustrated in FIGS. 4 to 6, the third support portion 103 is in contact with the second surface 12 when the placement unit 10 is in the first state and the second state.

As described above, The at least two first support portions 101 may be in contact with the second surface 12 when the placement unit 10 is in the first state, the at least two second support portions 102 may be in contact with the second surface 12 when the placement unit 10 is in the second state, and the at least two third support portions 103 may be in contact with the second surface when the placement unit 10 is in the first state and the second state. This is because, according to the configuration, the placement unit 10 is supported at least at four points in both the first state and the second state, and the attitude of the placement unit 10 is stabilized in both the first state and the second state.

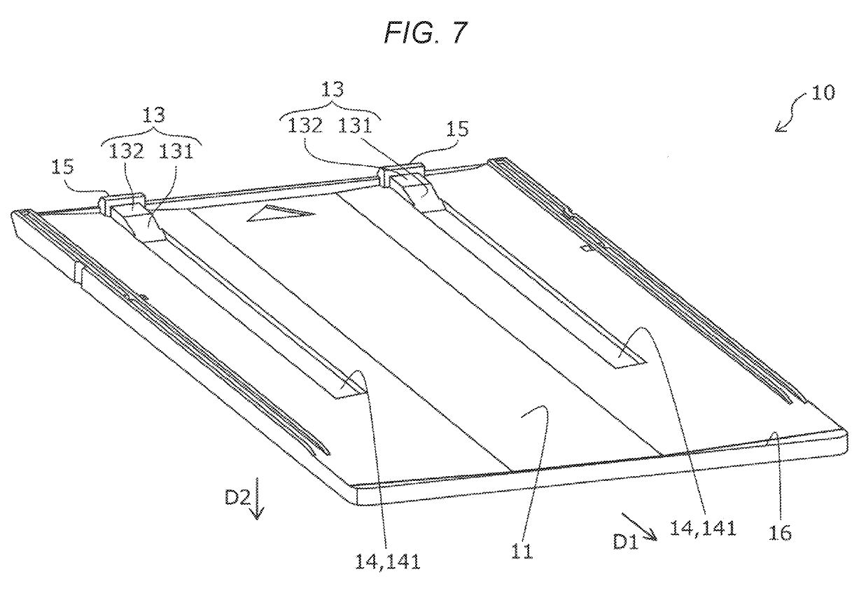

As illustrated in FIGS. 7, 8, 10, and 11, the placement unit 10 has the groove portions 14. The groove portions 14 can avoid a state of being supported by the fourth support portions 104 when the placement unit 10 is displaced between the first state and the second state. A bottom surface 141 of the groove portion 14 is located below the contact surface 132 of the protruding portion 13. In other words, the bottom surface 141 of the groove portion 14 is located downstream of the contact surface 132 of the protruding portion 13 in a depth direction D2 from the first surface 11 toward the second surface 12. Furthermore, the bottom surface 141 of the groove portion 14 is located below the first surface 11. In other words, the bottom surface 141 of the groove portion 14 is located downstream of the first surface 11 in the depth direction D2 from the first surface 11 toward the second surface 12. As illustrated in FIGS. 7, 8, 10, and 11, the groove portion 14 is coupled to the inclined surface 131 in the pull-out direction D1. The groove portion 14 is disposed above the fourth support portion 104, in other words, disposed to overlap at least the trajectory of the fourth support portion 104 when the placement unit 10 is displaced between the first state and the second state when viewed from the depth direction D2.

According to the configuration, in the recording apparatus 1, the angle of the placement unit 10 can be changed as the placement unit 10 is pulled out. Note that, in the configuration of the present embodiment, the contact surface 132 is protruded from the first surface 11, but by using the groove portion 14 having such a configuration, for example, a gap can be generated in height between the bottom surface 141 of the groove portion 14 and the contact surface 132 without protruding the contact surface 132 from the first surface 11. Even in this case, the inclined surface 131 is provided between the groove portion 14 and the contact surface 132, and thus the angle of the placement unit 10 can be changed along with the pull-out operation.

As illustrated in FIGS. 4 to 8 and FIGS. 9 to 13, the placement unit 10 has a restriction portion 15 upstream of the contact surface 132 in the pull-out direction D1. The restriction portion 15 protrudes upward, in other words, is located upstream of the contact surface 132 in the depth direction D2, and is configured to restrict the movement of the placement unit 10 in the pull-out direction D1 by coming into contact with the fourth support portion 104.

With the restriction portion 15 having such a configuration, it is possible to prevent the placement unit 10 from coming off the recording apparatus 1 when the placement unit 10 is pulled out in the pull-out direction D1. The restriction portion 15 needs to be located upstream of the contact surface 132 in the depth direction D2. Therefore, the further upstream the contact surface 132 is located in the depth direction D2, the thicker the placement unit 10.. However, since the groove portion 14 is provided, it is possible to restrict the movement of the placement unit 10 in the pull-out direction D1 by the restriction portion 15 and the fourth support portion 104 while suppressing the thickness of the placement unit 10, that is, it is possible to prevent the placement unit 10 from coming off the recording apparatus 1.

As described above, the recording apparatus 1 includes the feed tray 6 on which the medium M on which recording is to be performed by the recording unit 3 is placed and the feed roller 7 that feeds the medium M placed on the feed tray 6, and as illustrated in FIG. 4, the placement unit 10 is disposed at a position overlapping the feed roller 7 when viewed from the vertical direction in the first state. According to the configuration, the recording apparatus 1 can be miniaturized.

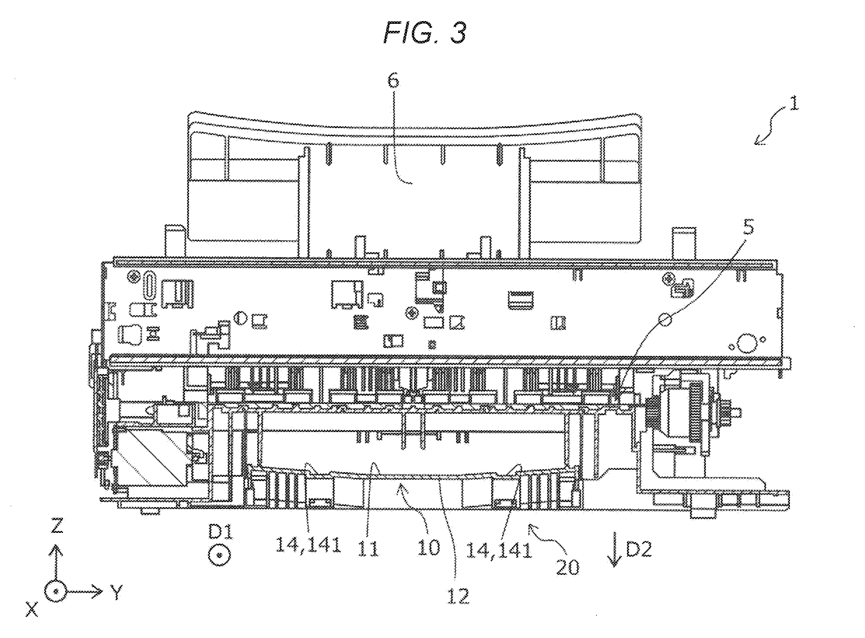

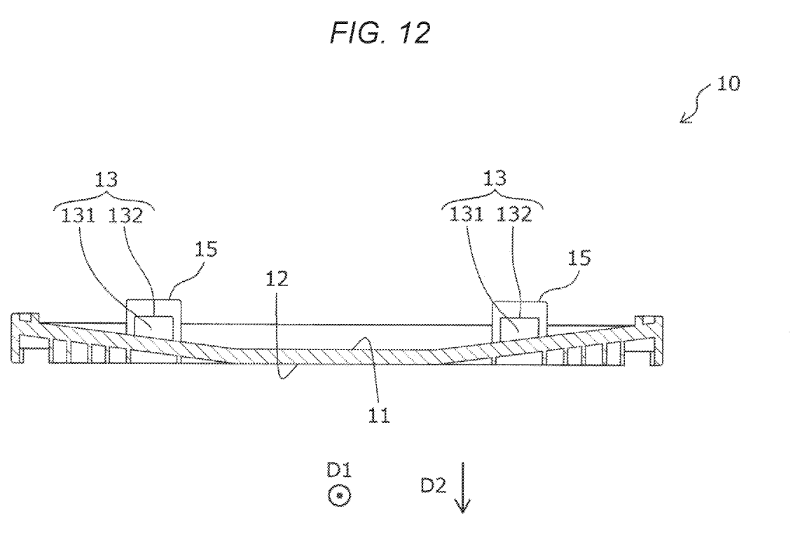

As illustrated in FIGS. 3 and 12, the first surface 11 of the placement unit 10 has a curved shape in which the center is recessed in the depth direction D2 in the cross section viewed from the pull-out direction D1. According to the configuration, the medium M can be placed in a curved manner, and the alignment of the medium M placed on the placement unit 10 can be improved.

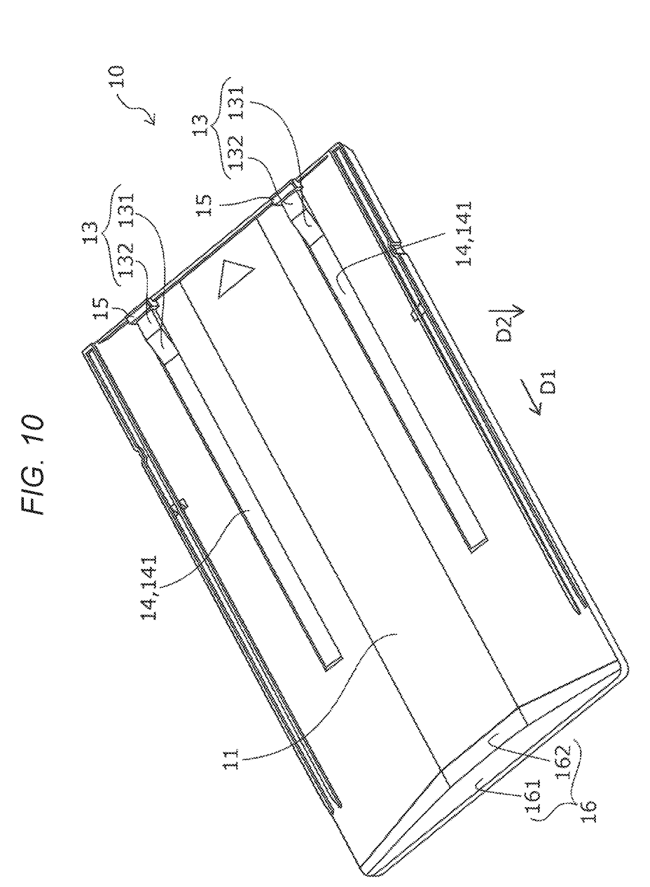

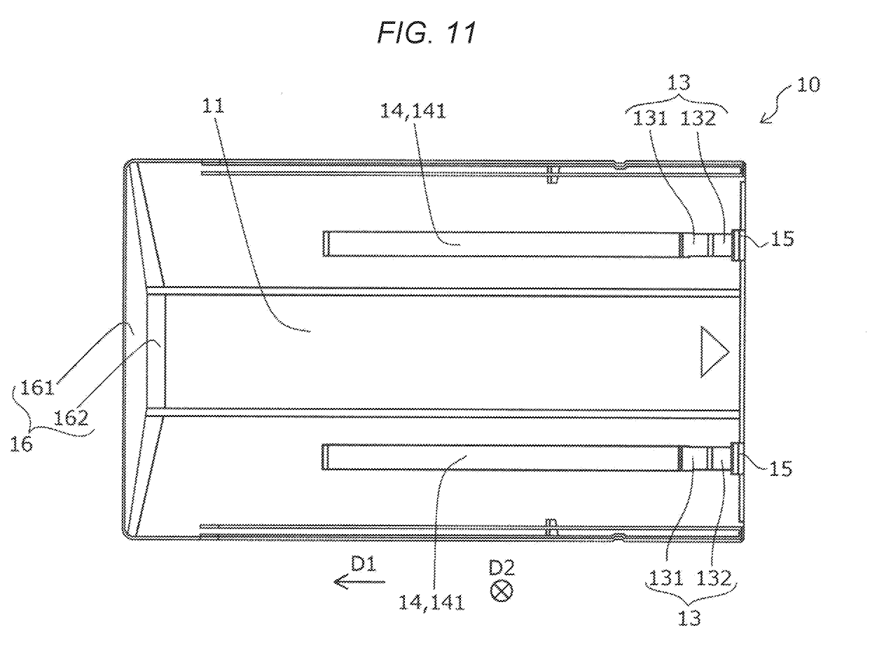

As illustrated in FIGS. 10, 11, and the like, the placement unit 10 includes a handle portion 16 in an upstream end portion in the pull-out direction D1. The handle portion 16 includes a wall portion 161 protruding upward from the first surface 11 and a curved surface 162 coupling the first surface 11 and the wall portion 161. Since the recording apparatus 1 includes the handle portion 16 having such a configuration, the user can easily pull out the placement unit 10. Since the wall portion 161 has no protrusion or the like and has a straight outer shape line when viewed from the pull-out direction D1, the appearance is good.

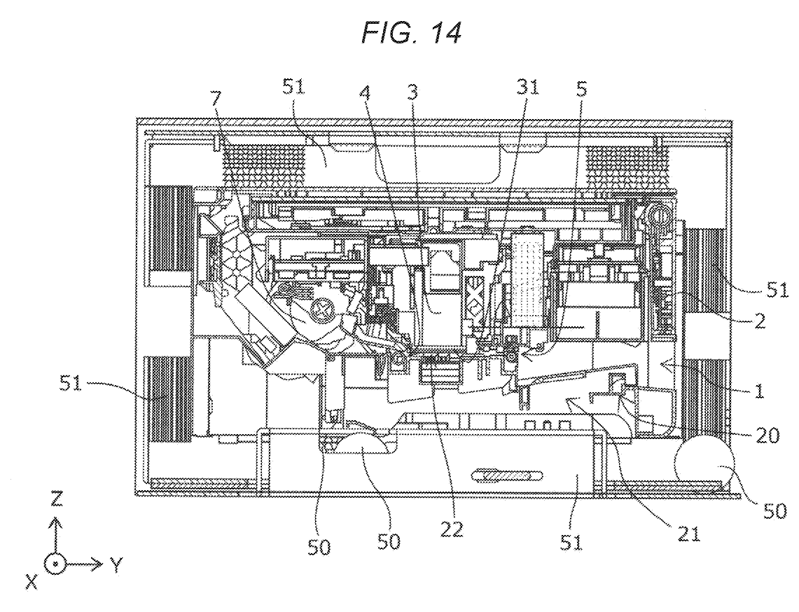

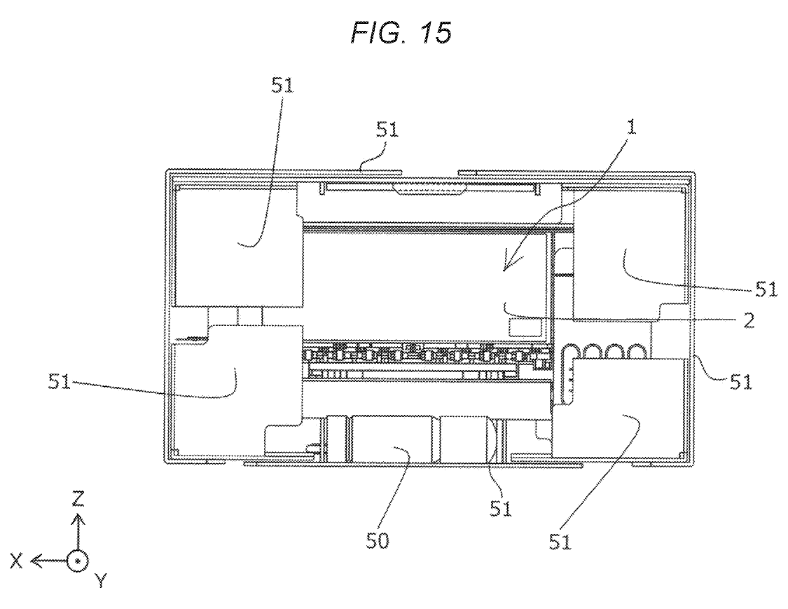

Next, a packed state and a packing method of the recording apparatus 1 when packing the recording apparatus 1 will be described with reference to FIGS. 14 to 16. The recording apparatus 1 of the present embodiment has a compact size for easy packing and can be suitably packed including the placement unit 10 in addition to the advantage that the medium M can be suitably placed on the placement unit 10 without increasing the number of components. Therefore, the box for packing can be downsized, and the conveyance cost can be reduced.

As described above, the recording apparatus 1 according to the present embodiment includes the feed tray 6, at least a part of which is provided downstream of the housing 2 in the pull-out direction D1, on which the medium M on which recording is to be performed by the recording unit 3 is placed, and the feed roller 7 that feeds the medium M placed on the feed tray 6. Then, the medium M placed on the feed tray 6 is ejected to the placement unit 10 upstream in the pull-out direction D1.

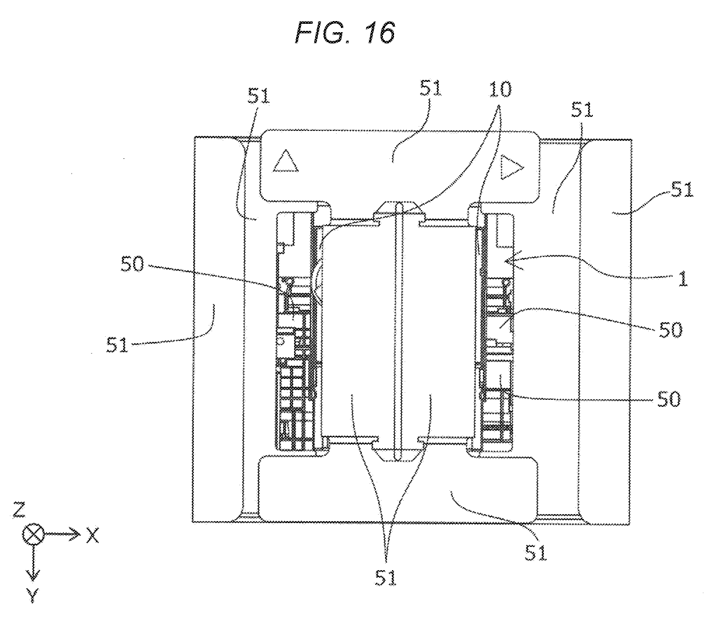

Here, in the recording apparatus 1 of the present embodiment, the recording unit 3 is a recording device that performs recording on the medium M conveyed from the feed tray 6 to the placement unit 10 by ejecting the liquid supplied from the container 50 that contains the liquid. FIGS. 14 to 16 illustrate a state in which the container 50 is detached from a predetermined attachment position of the recording apparatus 1 and housed in a packing member 51. As illustrated in FIGS. 14 and 16, the housing 2 includes a storage portion 21 capable of storing at least a part of the container 50. In other words, the storage portion is a recess provided in the housing 2. The storage portion 21 may be capable of storing the entire container 50. According to the configuration, in the recording apparatus 1, the container 50 can be stored in the housing 2 at the time of packing, and a space for installing the container 50 can be reduced outside the housing 2.

Furthermore, the storage portion 21 is configured to be capable of storing at least a part of the container 50 held by the packing member 51. According to the configuration, it is possible to prevent the container 50 from moving in the storage portion 21.

In the recording apparatus 1 of the present embodiment, at the time of packing, at least part of a plurality of containers 50 can be stored in the storage portion 21 after the placement unit 10 is set in the first state. In other words, when packing the recording apparatus 1 of the present embodiment, it is possible to implement a packing method of storing at least a part of the container 50 in the storage portion 21 with the placement unit 10 set in the first state. When packing the recording apparatus 1, by storing at least a part of the container 50 in the storage portion 21 with the placement unit 10 set in the first state, it is possible to prevent the placement unit 10 from being detached and set outside the housing 2, and it is possible to prevent an increase in size of the package.

In contrast, when packing the recording apparatus 1 of the present embodiment, it is also possible to detach the placement unit 10 from the recording apparatus 1 and to store at least a part of the container 50 in the storage portion 21 that is widened by detaching the placement unit 10. FIG. 14 illustrates a state in which the storage unit 21 is widened by detaching the placement unit 10. From another point of view, in the recording apparatus 1 of the present embodiment, the placement unit 10 is provided in a part of the storage portion 21, and when the recording apparatus 1 is packed, a packing method of detaching the placement unit 10 from the recording apparatus 1 and storing at least a part of the container 50 in the storage portion 21 can be performed. In this way, a large number of containers 50 can be stored in the storage portion 21. Therefore, it is possible to particularly effectively suppress an increase in size of the package.

Here, in the recording apparatus 1 of the embodiment, the storage portion 21 is located below the recording unit 3. Furthermore, for example, also when packing the recording apparatus 1, the storage portion 21 may be positioned below the recording unit 3. In this way, even when the liquid in the container 50 leaks, it is possible to reduce the possibility that the liquid adheres to the recording unit 3.

In the recording apparatus 1 of the present embodiment, the storage portion 21 is located below the feed roller 7. For example, also when packing the recording apparatus 1, the storage portion 21 may be positioned below the feed roller 7. In this way, even when the liquid in the container 50 leaks, it is possible to reduce the possibility that the liquid adheres to the feed roller 7.

Furthermore, in the recording apparatus 1 of the present embodiment, the storage unit 21 is located below a conveyance path 22 of the medium M illustrated in FIGS. 2 and 14. Here, the conveyance path 22 of the medium M refers to at least a part of the conveyance path of the medium M conveyed from the feed tray 6 to the placement unit 10. Then, for example, also when packing the recording apparatus 1, the storage portion 21 may be positioned below the conveyance path 22 of the medium M. In this way, even when the liquid in the container 50 leaks, it is possible to reduce the possibility that the liquid adheres to the conveyance path 22 of the medium M.

The present disclosure is not limited to the embodiment and the modifications described above and various modifications can be made within the scope of the disclosure set forth in the appended claims, and it is obvious that these modifications also fall within the scope of the present disclosure.

What is claimed is:

1. A recording apparatus comprising:
a housing;
a recording unit that performs recording on a medium;
an ejection unit that ejects the medium on which recording has been performed by the recording unit; and
a placement unit having a first surface on which the medium ejected by the ejection unit is placeable and formed of one member, wherein
the housing has a support unit configured to support the placement unit,
the placement unit is configured to be displaced between a first state in which the entire placement unit is located in the housing and a second state in which at least a part of the placement unit protrudes from the housing by moving along a pull-out direction in contact with the support unit, and
the support unit supports the placement unit inclined at a first angle with respect to an installation surface of the recording apparatus in the first state, and supports the placement unit inclined at a second angle larger than the first angle with respect to the installation surface in the second state.

2. The recording apparatus according to claim 1, wherein
the placement unit has a protruding portion provided on the first surface,
the support unit has a first support portion configured to come into contact with a second surface that is a surface opposite to the first surface, a second support portion located downstream of the first support portion in the pull-out direction and configured to come into contact with the second surface, a third support portion located downstream of the second support portion in the pull-out direction and configured to come into contact with the second surface, and a fourth support portion configured to come into contact with the protruding portion in the second state,
the protruding portion has an inclined surface inclined such that a protrusion distance with respect to the first surface decreases toward the pull-out direction, and a contact surface coupled to the inclined surface on a side opposite to the pull-out direction, and
the fourth support portion slides on the inclined surface and the contact surface when the placement unit is displaced from the first state to the second state.

3. The recording apparatus according to claim 2, wherein
at least two of each of the first support portion, the second support portion, and the third support portion are provided at a distance in an apparatus width direction intersecting the pull-out direction,
the first support portion comes into contact with the second surface when the placement unit is in the first state,
the second support portion comes into contact with the second surface when the placement unit is in the second state, and
the third support portion comes into contact with the second surface when the placement unit is in both the first state and the second state.

4. The recording apparatus according to claim 2, wherein
the placement unit has a groove portion configured to avoid a state of being supported by the fourth support portion,
a bottom surface of the groove portion is located downstream of the contact surface in a depth direction from the first surface toward the second surface, and
the groove portion is coupled to the inclined surface in the pull-out direction, overlaps a trajectory of the fourth support portion when at least the placement unit is displaced between the first state and the second state when viewed from the depth direction, and overlaps a trajectory of the fourth support portion when at least the placement unit is displaced between the first state and the second state when viewed from the pull-out direction.

5. The recording apparatus according to claim 4, wherein
the placement unit has a restriction portion upstream of the contact surface in the pull-out direction, and
the restriction portion is located upstream of the contact surface in the depth direction and restricts the movement of the placement unit in the pull-out direction by coming into contact with the fourth support portion.

6. The recording apparatus according to claim 1, comprising:
a feed tray on which a medium on which recording is to be performed by the recording unit is placed; and
a feed roller that feeds the medium placed on the feed tray, wherein
the placement unit overlaps the feed roller when viewed from a vertical direction in the first state.

7. The recording apparatus according to claim 1, wherein
the first surface has a curved shape in which a center is recessed in a cross section viewed from the pull-out direction.

8. The recording apparatus according to claim 7, wherein
the placement unit has a handle portion in an upstream end portion in the pull-out direction, and
the handle portion has a wall portion protruding from the first surface and a curved surface coupling the first surface and the wall portion.

9. The recording apparatus according to claim 1, comprising:
a feed tray, at least a part of which is provided downstream of the housing in the pull-out direction, on which a medium on which recording is to be performed by the recording unit is placed; and
a feed roller that feeds the medium placed on the feed tray, wherein
the medium placed on the feed tray is ejected to the placement unit toward upstream in the pull-out direction,
the recording unit performs recording on the medium conveyed from the feed tray to the placement unit by ejecting liquid supplied from a container that contains the liquid, and
the housing has a storage portion configured to store at least a part of the container.

10. The recording apparatus according to claim 9, wherein
the storage portion is configured to store at least a part of the container held by a packing member.

11. A packing method for the recording apparatus according to claim 9, comprising storing at least a part of the container in the storage portion with the placement unit set in the first state when packing the recording apparatus.

12. A packing method for the recording apparatus according to claim 9, the placement unit is provided in a part of the storage portion, comprising detaching the placement unit from the recording apparatus and storing at least a part of the container in the storage portion when packing the recording apparatus.

13. The packing method according to claim 11, wherein
the storage portion is positioned below the recording unit when the recording apparatus is packed.

14. The packing method according to claim 11, wherein
the storage portion is positioned below the feed roller when the recording apparatus is packed.

15. The packing method according to claim 11, wherein
the storage portion is positioned below a conveyance path of the medium conveyed from the feed tray to the placement unit when the recording apparatus is packed.
